(19) United States
(12) Patent Application Publication
(10) Pub. No.: US 2010/0068468 A1
(43) Pub. Date: Mar. 18, 2010

(54) Composites and devices including nanoparticles

(76) Inventors: Seth Coe-Sullivan, Belmont, MA (US); Craig Breen, Somerville, MA (US); Marshall Cox, North Haven, CT (US); Peter T. Kazlas, Sudbury, MA (US)

Correspondence Address: QD Vision, Inc., 4th Floor, 313 Pleasant Street, Watertown, MA, 02472, US

(21) Appl. No.: 12/455,144

(22) Filed: May 28, 2009

Related U.S. Application Data
(63) Continuation of application No. PCT/US07/24750, filed on Dec. 3, 2007.
(60) Provisional application No. 60/868,108, filed on Dec. 1, 2006.

(51) Int. Cl. B32B 5/16; B32B 3/00

(52) U.S. Cl. 428/172; 428/323

(57) ABSTRACT

A composite including a first layer comprising nanoparticles, at least a portion of which include a ligand attached to a surface of a nanoparticle, and a second layer disposed over a predetermined area of the first layer, wherein the second layer is continuous or uninterrupted by voids across the predetermined area, and has a thickness less than or equal to about 30 nm. In certain preferred embodiments, there is a chemical affinity between the ligand and the second layer. A device including the above composite and related methods are also disclosed.

This application is a continuation of commonly owned PCT Application No. PCT/US2007/024750 filed 3 Dec. 2007, which was published in the English language as PCT Publication No. WO 2008/070028 on 12 Jun. 2008. The PCT Application claims priority to U.S. Application Nos. 60/868,108, filed 1 Dec. 2006. The disclosures of each of the foregoing applications are hereby incorporated herein by reference in their entireties.

### TECHNICAL FIELD OF THE INVENTION

The technical field of the invention relates to nanoparticles (e.g., semiconductor nanocrystals (or “quantum dots”)) and compositions, devices, displays and methods including same.

### BACKGROUND

In the past decade, much effort has been devoted to the continuous improvement of the basic OLED materials set. While the number of possible small molecules and polymers is theoretically infinite, the multi-parameter optimization of organic materials for lifetime, efficiency, color and manufacturing process to date has prevented the creation of a clear leader for the red, green and blue emissive materials within OLEDs.

Fluorescent small molecules have demonstrated the best combination of lifetime and manufacturability to date, as demonstrated by the multitude of products on the market today. Phosphorescent small molecules are the clear leader in efficiency, with internal quantum efficiencies that approach perfection. However, only polymeric and a recently developed subset of molecular materials are solution-processable, enabling the possibility of manufacturing scale beyond Gen 4 substrate sizes.

### SUMMARY OF THE DESCRIPTION

The present invention relates to a composite including nanoparticles, a device including a composite including nanoparticles, and a method for forming a layered structure.

In accordance with one aspect of the invention, there is provided a composite including a first layer comprising nanoparticles, at least a portion of which include a ligand attached to a surface of a nanoparticle, and a second layer disposed over a predetermined area of the first layer, wherein the second layer is continuous or uninterrupted by voids across the predetermined area, and has a thickness less than or equal to about 30 nm. In certain embodiments, the second layer has a thickness less than or equal to about 25 nm. In certain embodiments, the second layer has a thickness less than or equal to about 20 nm. In certain embodiments, the second layer has a thickness less than or equal to about 15 nm. In certain embodiments, the second layer has a thickness less than or equal to about 10 nm. In certain embodiments, the second layer has a thickness less than or equal to about 5 nm.

In certain embodiments, the thickness of the second layer varies by less than or equal to 5 nm across the predetermined area.

In certain preferred embodiments, there is a chemical affinity between the ligand and the second layer. By including a ligand on a surface of at least a portion of the nanoparticles and a second layer in a composite wherein there is a chemical affinity between the ligand and the second layer, an improved interface can be achieved between the first and second layers of the composite. This improved interface can be advantageous in certain end-use applications of composites of the invention, including but not limited to devices (e.g., light emitting devices and displays including emissive materials comprising nanoparticles, e.g., semiconductor nanocrystals). In certain embodiments, substantially all, and preferable all, of the nanoparticles include a ligand on a surface of the nanoparticle with a chemical affinity for the second layer. In certain embodiments, more than one ligand can be attached to a nanoparticle. When more than one ligand is attached, the ligands can have the same or different chemical compositions. When ligands with different chemical compositions are attached, there is preferably a chemical affinity between at least one of the ligand compositions and the second layer. In certain most preferred embodiments, all or substantially all (e.g., greater than about 95%) of the ligands attached to nanoparticles in the first layer have a chemical affinity for the second layer.

In certain embodiments, the ligand includes an aromatic group.

In certain embodiments, the material included in the second layer has a chemical affinity for a ligand including an aromatic group.

In certain embodiments, the ligand includes an aliphatic group.

In certain embodiments, the material included in the second layer has a chemical affinity for a ligand including an aliphatic group.

In certain embodiments, the ligand is represented by the formula:

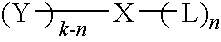

wherein k is 2, 3, 4 or 5, and n is 1, 2, 3, 4 or 5 such that k-n is not less than zero; X is O, S, S═O, SO₂, Se, Se═O, N, N═O, P, P═O, As, or As═O; each of Y and L, independently, is aryl, heteroaryl, or a straight or branched C₂₋₁₂ hydrocarbon chain optionally containing at least one double bond, at least one triple bond, or at least one double bond and one triple bond, the hydrocarbon chain being optionally substituted with one or more C₁₋₄ alkyl, C₂₋₄ alkenyl, C₂₋₄ alkynyl, C₁₋₄ alkoxy, hydroxyl, halo, amino, nitro, cyano, C₃₋₅ cycloalkyl, 3-5 membered heterocycloalkyl, aryl, heteroaryl, C₁₋₄ alkylcarbonyloxy, C₁₋₄ alkyloxycarbonyl, C₁₋₄ alkylcarbonyl, or formyl and the hydrocarbon chain being optionally interrupted by —O—, —S—, —N(R^{a})—, —N(R^{a})—C(O)—O—, —O—C(O)—N(R^{a})—, —N(R^{a})—C(O)—N(R^{b})—, —O—C(O)—O—, —P(R^{a})—, or —P(O)(R^{a})—; and each of R^{a} and R^{b}, independently, is hydrogen, alkyl, alkenyl, alkynyl, alkoxy, hydroxylalkyl, hydroxyl, or haloalkyl.

In certain embodiments, the second layer has a chemical affinity for a ligand represented by the above formula.

In certain embodiments, the first layer comprises a monolayer including nanoparticles. In certain embodiments, a monolayer includes nanoparticles having the same composition and/or properties. In certain embodiments, a monolayer includes a mixture of two or more nanoparticles having different compositions and/or properties. In certain embodiments, the first layer comprises more than one monolayer including nanoparticles. In certain embodiments including more than one monolayer, each monolayer can include nanoparticles having compositions and/or properties that are different from those of one or all of the other monolayer(s).

In certain embodiments, the first layer is unpatterned.

In certain embodiments, the first layer is patterned.

In certain embodiments, the second layer is unpatterned.

In certain embodiments, the second layer is patterned.

In certain embodiments, the first layer is patterned and the second layer comprises a continuous layer disposed over the first layer.

In certain embodiments, the first layer comprises a continuous layer and the second layer comprises a patterned layer disposed over two or more predetermined areas of the first layer.

In certain embodiments, both the second and first layers have the same, or substantially the same pattern, and the pattern of the second layer overlays the pattern of the first layer.

In certain embodiments, the second layer comprises an electrically insulating material.

In certain embodiments, the second layer comprises a semiconductor material.

In certain embodiments, the second layer is disposed (e.g., deposited) directly on the predetermined area of the first layer.

In certain embodiments, the second layer comprises a material capable of transporting charge. In certain embodiments, a material capable of transporting charge can comprise a material capable of transporting electrons. In certain embodiments, a material capable of transporting charge can comprise a material capable of transporting holes. Either or both of these layers can comprise organic or inorganic materials. Examples of inorganic material include, but are not limited to, inorganic semiconductors. The inorganic material can be amorphous or polycrystalline. An organic charge transport material can be polymeric or non-polymeric.

In certain embodiments, the second layer comprises a charge blocking material (e.g., a hole blocking material).

In certain embodiments, the second layer comprises an organic material. In certain preferred embodiments, there is a chemical affinity between the ligand and the organic material included in the second layer. Non-limiting examples of organic materials include organic small molecules, organic polymers, organometallic compounds, metal-organic complexes, hydrocarbons, and other carbon based materials. In certain embodiments, the organic material comprises a matrix material. In certain embodiments, the organic material comprises a mixture of two or more different materials. In certain embodiments, for example, the mixture can comprise a solid solution or a doped material. In certain embodiments, an organic material can include molecules comprising aromatic and aliphatic moieties.

In certain embodiments, the second layer comprises an evaporable material. In certain preferred embodiments, there is a chemical affinity between the ligand and the evaporable material included in the second layer. In certain embodiments, the evaporable material comprises an inorganic material. Non-limiting examples include silicon oxide, zinc oxide, and other metal oxides. In certain embodiments, an evaporable material comprises an organic material. Non-limiting examples include organic small molecules, and organic polymers. In certain embodiments, an evaporable material comprises an organic or inorganic materials that can be deposited by physical vapor deposition techniques. In certain embodiments, an evaporable material comprises an organic or inorganic materials that can be deposited by chemical vapor deposition techniques. In certain embodiments, evaporable materials comprise evaporable materials useful in fabricating organic light emitted devices. Such materials are known or can be readily ascertained by one of ordinary skill in the art. In certain embodiments, an evaporable material can comprise a mixture of two or more different materials. In certain embodiments, an evaporable material can include molecules comprising aromatic and aliphatic moieties.

In certain embodiments, the second layer comprises a base material (e.g., an organic or inorganic material) and less than 75% by weight nanoparticles. In certain embodiments, the base material includes less than 50% by weight nanoparticles. In certain embodiments, the base material includes less than 25% by weight nanoparticles. In certain embodiments, the base material includes less than 10% by weight nanoparticles. In certain embodiments, the base material includes less than 5% by weight nanoparticles. In certain embodiments, the base material includes less than 3% by weight nanoparticles. In certain embodiments, the second layer includes a base material without nanoparticles.

In certain preferred embodiments, there is a chemical affinity between the ligand and the base material included in the second layer. In certain embodiments, the base material comprises an organic material. In certain embodiments, the base material comprises an inorganic material. In certain embodiments, the base material comprises a small molecule material. In certain embodiments, the base material comprises a polymer. In certain embodiments, the base material comprises a matrix material. In certain embodiments, the base material comprises a mixture of two or more different materials. In certain embodiments, a base material can include molecules comprising aromatic and aliphatic moieties.

The nanoparticles can comprise nanocrystals. The nanoparticles can comprise metallic nanoparticles, ceramic nanoparticles, or semiconductor nanoparticles, such as semiconductor nanocrystals.

In certain preferred embodiments, the nanoparticles comprise semiconductor nanocrystals.

In certain preferred embodiments, the nanoparticles comprise semiconductor nanocrystals including a core and a shell disposed on at least a portion of the core.

In accordance with another aspect of the invention, there is provided a device including the above composite.

In certain embodiments, the device is a light-emitting device comprising the above composite. In certain embodiments, the device is a display comprising the above composite. Light emitting devices and displays including semiconductor nanocrystals are described, for example, in International Application No. PCT/US2007/013152, entitled “Light-Emitting Devices And Displays With Improved Performance”, of QD Vision, Inc. et al., filed 4 Jun. 2007, which is hereby incorporated herein by reference in its entirety.

In certain embodiments, a first layer comprising nanoparticles is formed on a substrate. In certain other embodiments, one or more other layers are formed on the substrate before the first layer is formed thereon. In certain embodiments, there is also a chemical affinity between the ligands on the nanoparticles and the surface (e.g., substrate or other layer or material) on which the nanoparticles are deposited. Including the above composite in a device can improve the performance of such device (e.g., light emitting devices and/or displays including nanoparticles) by improving the morphology of the interface between the first and second layers.

In accordance with another aspect of the invention, there is provided a method of forming a layered structure comprising: forming a first layer comprising nanoparticles on a surface, and forming a second layer having a thickness less than or equal to 30 nm on a predetermined area of the first layer, wherein the second layer is continuous across the predetermined area of the first layer.

In certain embodiments, the nanoparticles comprise semiconductor nanocrystals.

In certain embodiments, the thickness of the second layer varies by less than or equal to 5 nm across the predetermined area.

In certain preferred embodiments, at least a portion of the nanoparticles include a ligand attached to a surface of a nanoparticle. In certain embodiments, more than one ligand can be attached to a nanoparticle. When more than one ligand is attached, the ligands can have the same or different chemical compositions. When ligands with different chemical compositions are attached, there is preferably a chemical affinity between at least one of the ligand compositions and the second layer. In certain most preferred embodiments, all or substantially all (e.g., greater than about 95%) of the ligands attached to nanoparticles in the first layer have a chemical affinity for the second layer.

In certain preferred embodiments, there is a chemical affinity between the ligand and the second layer. By including a ligand on a surface of at least a portion of the nanoparticles and a second layer in a composite wherein there is a chemical affinity between the ligand and the second layer, an improved interface can be achieved between the first and second layers of the composite. This improved interface can be advantageous in certain end-use applications of composites of the invention, including but not limited to devices (e.g., light emitting devices and displays including emissive materials comprising nanoparticles, e.g., semiconductor nanocrystals).

Examples of nanoparticles, first layers, second layers useful in the method of the invention are described above and in the detailed description.

In certain aspects and embodiments of the inventions described or contemplated by this general description, the following detailed description, and claims, the desired ligand can be formed on the nanocrystals during preparation thereof. Alternatively, if the ligand(s) formed on the nanocrystals during preparation (also referred to herein as native ligands) are not the desired ligand, all or a portion of the native ligands can be replaced by the desired ligand(s). Techniques for exchanging ligands are known or can be readily ascertained by one of ordinary skill in the art.

In certain aspects and embodiments of the inventions described or contemplated by this general description, the following detailed description, and claims, the semiconductor nanocrystals or other nanoparticles included in the first layer can comprise the same or the same or different composition. In certain embodiments, a semiconductor nanocrystal can include a core comprising a first semiconductor material and a shell comprising a second semiconductor material. The shell is disposed over at least a portion of the core. In certain embodiments, the shell is disposed over substantially all of the outer surface of the core. (A semiconductor nanocrystal including a core and shell is also referred to as having a core/shell structure.) Each first semiconductor film has a first band gap and each second semiconductor material has a second band gap. The second band gap can be larger than the first band gap. In certain embodiments, a nanocrystal can have a diameter of less than about 10 nanometers. In embodiments including a plurality of nanocrystals, the distribution of nanocrystal sizes is preferably monodisperse.

The foregoing, and other aspects described herein, all constitute embodiments of the present invention.

It is to be understood that both the foregoing general description and the following detailed description are exemplary and explanatory only and are not restrictive of the invention as claimed. Other embodiments will be apparent to those skilled in the art from consideration of the description and drawings, from the claims, and from practice of the invention disclosed herein.

### BRIEF DESCRIPTION OF THE DRAWINGS

In the drawings:

FIG. 1 depicts an example of a semiconductor nanocrystals including a core/shell structure with ligands (or cap molecules) attached to the surface.

FIG. 2 illustrates a CIE chromaticity diagram depicting the cathode-ray-tube color standard and the potential semiconductor nanocrystal emission colors.

FIG. 3 schematically depicts an Atomic Force Microscope (AFM) image of a semiconductor nanocrystal monolayer.

FIG. 4 schematically depicts an example of device design including semiconductor nanocrystals.

FIG. 5 depicts Atomic Force Microscope images showing the effect of examples of ligand composition on semiconductor nanocrystal layer interface morphology. Images (a) and (b) are height and phase images respectively of a sample in which there is no chemical affinity between the ligands and the overlying layer, showing an interface with 50 nm height features. Images (c) and (d) show an interface at which there is chemical affinity between the ligands and overlying layer, reducing interface roughness by over an order of magnitude.

FIG. 6 depicts Atomic Force Microscope images showing 5 nm CBP thermally evaporated on an aliphatic ligand quantum dot monolayer.

FIG. 7 depicts Atomic Force Microscope images showing 15 nm CBP thermally evaporated on an aliphatic ligand quantum dot monolayer

FIG. 8 depicts Atomic Force Microscope images showing 5 nm CBP thermally evaporated on an aromatic ligand quantum dot monolayer

FIG. 9 depicts Atomic Force Microscope images showing the effect of ligand composition on QD layer interface morphology. Images (a) and (b) are height and phase images respectively of a sample with poorly engineered ligands, showing an interface with 50 nm height features. Images (c) and (d) show the QD interface after the ligands have been re-designed, improving certain interface roughness attributes by over an order of magnitude.

FIG. 10 depicts Atomic Force Microscope images showing Aromatic QDs on glass.

FIG. 11 depicts Atomic Force Microscope images showing 5 nm DOFL-CBP on Aromatic QDs.

FIG. 12 depicts Atomic Force Microscope images showing 15 nm DOFL-CBP on Aromatic QDs.

The attached figures are simplified representations presented for purposes of illustration only; the actual structures may differ in numerous respects, including, e.g., relative scale, etc.

For a better understanding to the present invention, together with other advantages and capabilities thereof, reference is made to the following disclosure and appended claims in connection with the above-described drawings.

### DETAILED DESCRIPTION

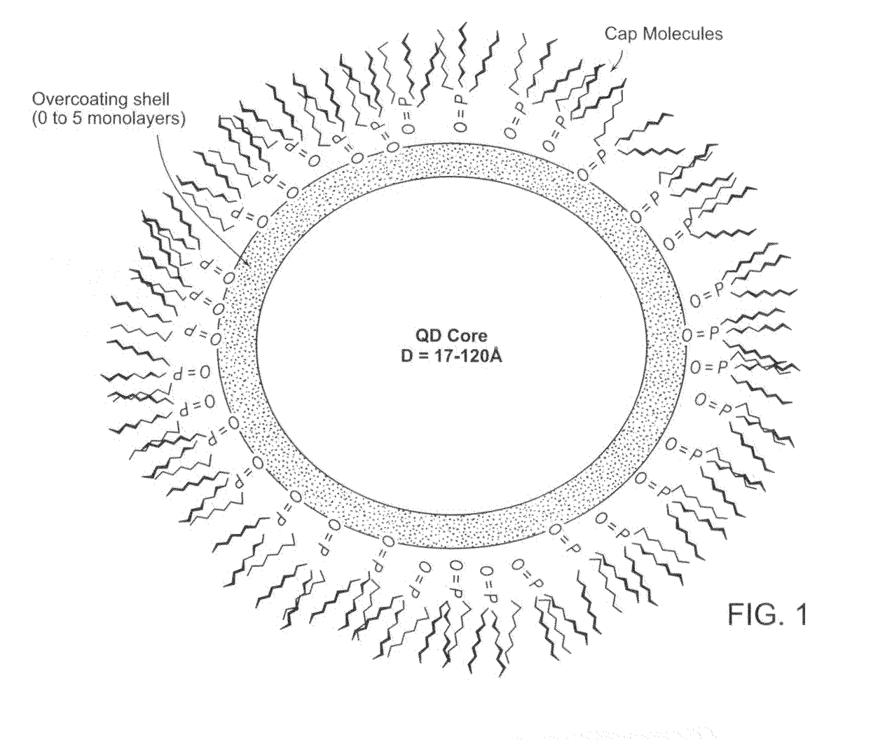

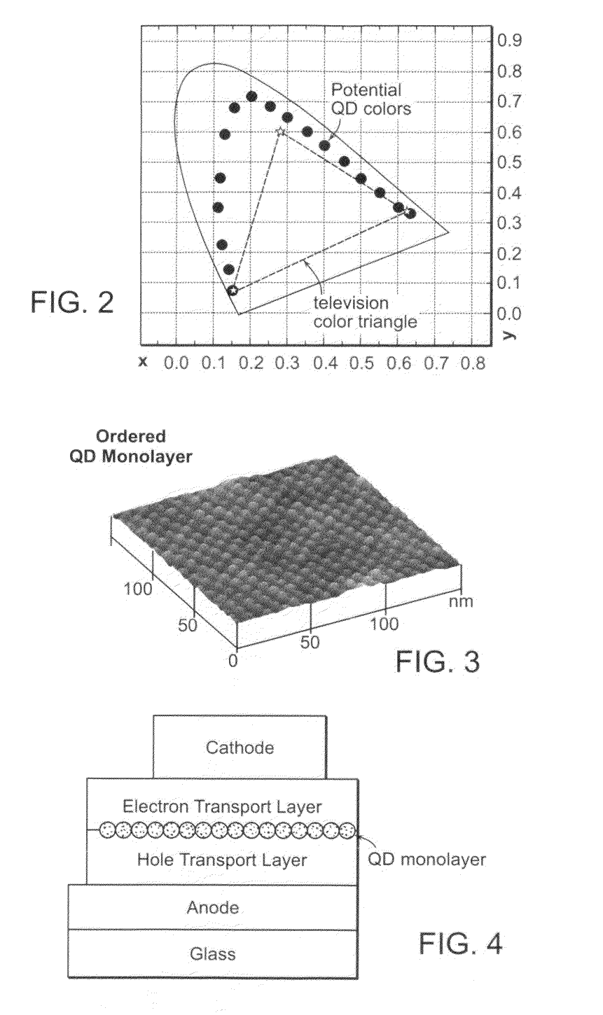

In a new generation of light emitting devices (also referred to as LEDs), an emissive material comprises inorganic nanoparticles, preferably, semiconductor nanocrystals. An example of a semiconductor nanocrystal including a core/shell structure is schematically shown in FIG. 1. Semiconductor nanocrystals, also referred to herein as nanocrystals or quantum dots, provide efficient emission and are also solution processable. In preferred embodiments, semiconductor nanocrystals comprise inorganic semiconductors and hence can be more stable in the presence of water vapor or oxygen than their organic semiconductor counterparts. Because of their quantum-confined emission properties, semiconductor nanocrystal luminescence can be narrow-band and can further yield highly saturated color emission, characterized by a single Gaussian spectrum. Because nanocrystal diameter controls the semiconductor nanocrystal optical band gap, fine tuning of emission wavelength can be accomplished through changes in both synthesis and structure is possible, simplifying the process for identifying and optimizing luminescent properties. It is expected that colloidal suspensions of semiconductor nanocrystals (also referred to in the art as solutions) can be made that: 1) can emit at a predetermined wavelength anywhere across the visible and infrared spectrum (see, e.g., FIG. 2); 2) can be more stable than organic lumophores in aqueous environments; 3) can have narrow full-width half-maximum (FWHM); 4) can be efficient emitters and 5) can be incorporated into working semiconductor nanocrystal light emitting devices (semiconductor nanocrystal-LEDs) that also include layers of commercially available charge transport materials.

In certain embodiments, a semiconductor nanocrystal-LEDs can have a device structure that generally appears quite similar to that of a small molecule OLED (see FIG. 4). For example, a light emitting device including an emissive material comprising semiconductor nanocrystals can include electron-transport, hole-transport, hole-injection and hole-blocking layers. The roles of the electron-transport, hole-transport, hole-injection and hole-blocking layers in a device with the depicted structure can be similar to those performed in an OLED device.

However, some design constraints for light emitting device including an emissive material comprising semiconductor nanocrystals are quite specific to semiconductor nanocrystals. Instead of using a host:dopant-based emissive layer as used in phosphorescent or fluorescent OLEDs, a thin layer of semiconductor nanocrystals is typically used as the emissive layer (depicted in FIG. 3 as a monolayer). Approaches using a blended semiconductor nanocrystal:transport material system may tend to suffer from nearly an order of magnitude less device efficiency due to poor control over exciton formation and recombination. For the more efficient non-blended devices, the advantage of using a thin semiconductor nanocrystal layer at monolayer thicknesses lies in the fact that the semiconductor nanocrystal to semiconductor nanocrystal-charge transport is not an efficient process, and can lead to higher voltage devices. This thin semiconductor nanocrystal layer need not be perfect over the entire display pixel, but rather is tolerant to defects of both omission and addition (e.g., less than a complete monolayer to more than one monolayer), which can ease the requirements on the manufacturing process.

Nanoparticles typically have an average maximum dimension smaller than 100 nm. Examples of nanoparticles include, for example, a nanocrystal, a nanotube (such as a single walled or multi-walled carbon nanotube), a nanowire, a nanorod, a dendrimer, organic nanocrystal, organic small molecule, other nano-scale or micro-scale material or mixtures thereof.

The nanoparticles can comprise, for example, metallic nanoparticles, ceramic nanoparticles, or semiconductor nanoparticles, such as semiconductor nanocrystals.

Nanoparticles can have various shapes, including, but not limited to, sphere, rod, disk, other shapes, and mixtures of various shaped particles.

Metallic nanoparticles can be prepared as described, for example, in U.S. Pat. No. 6,054,495, which is incorporated by reference in its entirety. The metallic nanoparticle can be a noble metal nanoparticle, such as a gold nanoparticle. Gold nanoparticles can be prepared as described in U.S. Pat. No. 6,506,564, which is incorporated by reference in its entirety. Ceramic nanoparticles can be prepared as described, for example, in U.S. Pat. No. 6,139,585, which is incorporated by reference in its entirety.

Narrow size distribution, high quality semiconductor nanocrystals with high fluorescence efficiency can be prepared using previously established literature procedures and used as the building blocks. See, C. B. Murray et al., J. Amer. Chem. Soc. 1993, 115, 8706, B. O. Dabbousi et al., J. Phys. Chem. B 1997, 101, 9463, each of which is incorporated by reference in its entirety. Other methods known or readily ascertainable by the skilled artisan can also be used.

In certain embodiments, nanoparticles comprise chemically synthesized colloidal nanoparticles (nanoparticles), such as semiconductor nanocrystals or quantum dots. In certain preferred embodiments, the nanoparticles have a diameter in a range from about 1 to about 10 nm. In certain embodiments, at least a portion of the nanoparticles, and preferably all of the nanoparticles, include one or more ligands attached to a surface of a nanoparticle. See, C. B. Murray et al., Annu. Rev. Mat. Sci., 30, 545-610 (2000), which is incorporated in its entirety. These zero-dimensional structures show strong quantum confinement effects that can be harnessed in designing bottom-up chemical approaches to create complex heterostructures with electronic and optical properties that are tunable with the size of the nanocrystals.

A light emitting device can have a structure such as shown in FIG. 4. A separate emissive layer is included between the hole transporting layer and the electron transporting layer. One of the electrodes of the structure is in contact with a substrate. Each electrode can contact a power supply to provide a voltage across the structure. Electroluminescence can be produced by the emissive layer of the heterostructure when a voltage of proper polarity is applied across the heterostructure.

Emission from semiconductor nanocrystals can occur at an emission wavelength when one or more of the nanocrystals is excited. The emission has a frequency that corresponds to the band gap of the quantum confined semiconductor material. The band gap is a function of the size of the nanocrystal. Nanocrystals having small diameters can have properties intermediate between molecular and bulk forms of matter. For example, nanocrystals based on semiconductor materials having small diameters can exhibit quantum confinement of both the electron and hole in all three dimensions, which leads to an increase in the effective band gap of the material with decreasing crystallite size. Consequently, both the optical absorption and emission of nanocrystals shift to the blue (i.e., to higher energies) as the size of the crystallites decreases.

The emission from the nanocrystal can be a narrow Gaussian emission band that can be tuned through the complete wavelength range of the ultraviolet, visible, or infrared regions of the spectrum by varying the size of the nanocrystal, the composition of the nanocrystal, or both. The narrow size distribution of a population of nanocrystals can result in emission of light in a narrow spectral range. The population can be monodisperse and can exhibit less than a 15% rms deviation in diameter of the nanocrystals, preferably less than 10%, more preferably less than 5%. Spectral emissions in a narrow range of no greater than about 75 nm, preferably 60 nm, more preferably 40 nm, and most preferably 30 nm full width at half max (FWHM) can be observed. The breadth of the emission decreases as the dispersity of nanocrystal diameters decreases.

Semiconductor nanocrystals can have high emission quantum efficiencies such as greater than 10%, 20%, 30%, 40%, 50%, 60%, 70%, or 80%. The semiconductor forming the nanocrystals can include Group IV elements, Group II-VI compounds, Group II-V compounds, Group III-VI compounds, Group III-V compounds, Group IV-VI compounds, Group I-III-VI compounds, Group II-IV-VI compounds, or Group II-IV-V compounds, for example, ZnS, ZnSe, ZnTe, CdS, CdSe, CdTe, HgS, HgSe, HgTe, AlN, AlP, AlAs, AlSb, GaN, GaP, GaAs, GaSb, GaSe, InN, InP, InAs, InSb, TlN, TlP, TlAs, TlSb, PbS, PbSe, PbTe, or mixtures thereof.

Examples of methods of preparing monodisperse semiconductor nanocrystals include pyrolysis of organometallic reagents, such as dimethyl cadmium, injected into a hot, coordinating solvent. This permits discrete nucleation and results in the controlled growth of macroscopic quantities of nanocrystals. Preparation and manipulation of nanocrystals are described, for example, in U.S. Pat. No. 6,322,901, which is incorporated herein by reference in its entirety. The method of manufacturing a nanocrystal is a colloidal growth process. Colloidal growth occurs by rapidly injecting an M donor and an X donor into a hot coordinating solvent. The injection produces a nucleus that can be grown in a controlled manner to form a nanocrystal. The reaction mixture can be gently heated to grow and anneal the nanocrystal. Both the average size and the size distribution of the nanocrystals in a sample are dependent on the growth temperature. The growth temperature necessary to maintain steady growth increases with increasing average crystal size. The nanocrystal is a member of a population of nanocrystals. As a result of the discrete nucleation and controlled growth, the population of nanocrystals obtained has a narrow, monodisperse distribution of diameters. The monodisperse distribution of diameters can also be referred to as a size. The process of controlled growth and annealing of the nanocrystals in the coordinating solvent that follows nucleation can also result in uniform surface derivatization and regular core structures. As the size distribution sharpens, the temperature can be raised to maintain steady growth. By adding more M donor or X donor, the growth period can be shortened.

The M donor can be an inorganic compound, an organometallic compound, or elemental metal. M is cadmium, zinc, magnesium, mercury, aluminum, gallium, indium or thallium. The X donor is a compound capable of reacting with the M donor to form a material with the general formula MX. Typically, the X donor is a chalcogenide donor or a pnictide donor, such as a phosphine chalcogenide, a bis(silyl) chalcogenide, dioxygen, an ammonium salt, or a tris(silyl) pnictide. Suitable X donors include dioxygen, bis(trimethylsilyl) selenide ((TMS)₂Se), trialkyl phosphine selenides such as (tri-n-octylphosphine) selenide (TOPSe) or (tri-n-butylphosphine) selenide (TBPSe), trialkyl phosphine tellurides such as (tri-n-octylphosphine) telluride (TOPTe) or hexapropylphosphorustriamide telluride (HPPTTe), bis(trimethylsilyl) telluride ((TMS)₂Te), bis(trimethylsilyl)sulfide ((TMS)₂S), a trialkyl phosphine sulfide such as (tri-n-octylphosphine) sulfide (TOPS), an ammonium salt such as an ammonium halide (e.g., NH₄Cl), tris(trimethylsilyl) phosphide ((TMS)₃P), tris(trimethylsilyl) arsenide ((TMS)₃As), or tris(trimethylsilyl) antimonide ((TMS)₃Sb). In certain embodiments, the M donor and the X donor can be moieties within the same molecule.

A coordinating solvent can help control the growth of the nanocrystal. The coordinating solvent is a compound having a donor lone pair that, for example, has a lone electron pair available to coordinate to a surface of the growing nanocrystal. Solvent coordination can stabilize the growing nanocrystal. Typical coordinating solvents include alkyl phosphines, alkyl phosphine oxides, alkyl phosphonic acids, or alkyl phosphinic acids, however, other coordinating solvents, such as pyridines, furans, and amines may also be suitable for the nanocrystal production. Examples of suitable coordinating solvents include pyridine, tri-n-octyl phosphine (TOP), tri-n-octyl phosphine oxide (TOPO) and tris-hydroxylpropylphosphine (tHPP). Technical grade TOPO can be used.

In certain methods, a non-coordinating or weakly coordinating solvent can be used.

Size distribution during the growth stage of the reaction can be estimated by monitoring the absorption line widths of the particles. Modification of the reaction temperature in response to changes in the absorption spectrum of the particles allows the maintenance of a sharp particle size distribution during growth. Reactants can be added to the nucleation solution during crystal growth to grow larger crystals. By stopping growth at a particular nanocrystal average diameter and choosing the proper composition of the semiconducting material, the emission spectra of the nanocrystals can be tuned continuously over the wavelength range of 300 nm to 5 microns. A nanocrystal typically has a diameter of less than 150 Å. A population of nanocrystals preferably has average diameters in the range of 15 Å to 125 Å.

The nanocrystal can be a member of a population of nanocrystals having a narrow size distribution. The nanocrystal can be a sphere, rod, disk, or other shape. The nanocrystal can include a core of a semiconductor material. The nanocrystal can include a core having the formula MX, where M is cadmium, zinc, magnesium, mercury, aluminum, gallium, indium, thallium, or mixtures thereof, and X is oxygen, sulfur, selenium, tellurium, nitrogen, phosphorus, arsenic, antimony, or mixtures thereof.

The core can have an overcoating on a surface of the core. The overcoating can be a semiconductor material having a composition different from the composition of the core. The overcoat of a semiconductor material on a surface of the nanocrystal can include a Group II-VI compounds, Group II-V compounds, Group III-VI compounds, Group III-V compounds, Group IV-VI compounds, Group I-III-VI compounds, Group II-IV-VI compounds, and Group II-IV-V compounds, for example, ZnS, ZnSe, ZnTe, CdS, CdSe, CdTe, HgS, HgSe, HgTe, AlN, AlP, AlAs, AlSb, GaN, GaP, GaAs, GaSb, GaSe, InN, InP, InAs, InSb, TlN, TlP, TlAs, TlSb, PbS, PbSe, PbTe, or mixtures thereof. For example, ZnS, ZnSe or CdS overcoatings can be grown on CdSe or CdTe nanocrystals. An overcoating process is described, for example, in U.S. Pat. No. 6,322,901. By adjusting the temperature of the reaction mixture during overcoating and monitoring the absorption spectrum of the core, over coated materials having high emission quantum efficiencies and narrow size distributions can be obtained.

The particle size distribution can be further refined by size selective precipitation with a poor solvent for the nanocrystals, such as methanol/butanol as described in U.S. Pat. No. 6,322,901. For example, nanocrystals can be dispersed in a solution of 10% butanol in hexane. Methanol can be added dropwise to this stirring solution until opalescence persists. Separation of supernatant and flocculate by centrifugation produces a precipitate enriched with the largest crystallites in the sample. This procedure can be repeated until no further sharpening of the optical absorption spectrum is noted. Size-selective precipitation can be carried out in a variety of solvent/nonsolvent pairs, including pyridine/hexane and chloroform/methanol. The size-selected nanocrystal population can have no more than a 15% rms deviation from mean diameter, preferably 10% rms deviation or less, and more preferably 5% rms deviation or less.

In methods carried out in a coordinating solvent, the outer surface of the nanocrystal can include a layer of compounds derived from the coordinating solvent used during the growth process. The surface can be modified by repeated exposure to an excess of a competing coordinating group to form an overlayer. For example, a dispersion of the capped nanocrystal can be treated with a coordinating organic compound, such as pyridine, to produce crystallites which disperse readily in pyridine, methanol, and aromatics but no longer disperse in aliphatic solvents. Such a surface exchange process can be carried out with any compound capable of coordinating to or bonding with the outer surface of the nanocrystal, including, for example, phosphines, thiols, amines and phosphates. The nanocrystal can be exposed to short chain polymers which exhibit an affinity for the surface and which terminate in a moiety having an affinity for a suspension or dispersion medium. Such affinity can improve the stability of the suspension and discourages flocculation of the nanocrystal.

Layers including nanocrystals can be formed by redispersing the powder semiconductor nanocrystals described above in a solvent system and drop casting films of the nanocrystals from the dispersion. The solvent system for drop casting depends on the chemical character of the outer surface of the nanocrystal, i.e., whether or not the nanocrystal is readily dispersible in the solvent system. The drop cast films are dried in an inert atmosphere for about 12 to 24 hours before being dried under vacuum.

In certain embodiments, a first layer comprising nanoparticles is formed directly on a substrate. In certain other embodiments, one or more other layers are formed on the substrate before the first layer is formed thereon. In certain embodiments, there is also a chemical affinity between the ligands on the nanoparticles and the surface (e.g., substrate or other layer or material) on which the nanoparticles are deposited.

Alternatively, a layer comprising semiconductor nanocrystals can be deposited by printing techniques such as those disclosed in, International Application No. PCT/US2007/008873, entitled “Composition Including Material, Methods Of Depositing Material, Articles Including Same And Systems For Depositing Material”, of QD Vision, Inc. et al., filed 9 Apr. 2007; International Application No. PCT/US2007/009255, entitled “Methods Of Depositing Material, Methods Of Making A Device, And Systems And Articles For Use In Depositing Material”, of QD Vision, Inc., filed 13 Apr. 2007; International Application No. PCT/US2007/014711, entitled “Methods For Depositing Nanomaterial, Methods For Fabricating A Device, And Methods For Fabricating An Array Of Devices”, of QD Vision, Inc. et al., filed 25 Jun. 2007; International Application No. PCT/US2007/008705, entitled “Methods And Articles Including Nanomaterial”, of QD Vision, Inc., filed 9 Apr. 2007, and International Application No. PCT/US2007/008721, entitled “Methods Of Depositing Nanomaterial & Methods Of Making A Device”, of QD Vision, Inc., filed 9 Apr. 2007, each of the foregoing being hereby incorporated herein by reference in its entirety.

Transmission electron microscopy (TEM) can provide information about the size, shape, and distribution of the nanocrystal population. Powder x-ray diffraction (XRD) patterns can provided the most complete information regarding the type and quality of the crystal structure of the nanocrystals. Estimates of size are also possible since particle diameter is inversely related, via the X-ray coherence length, to the peak width. For example, the diameter of the nanocrystal can be measured directly by transmission electron microscopy or estimated from x-ray diffraction data using, for example, the Scherrer equation. It also can be estimated from the UV/Vis absorption spectrum.

Narrow FWHM of nanocrystals can result in saturated color emission. This can lead to efficient nanocrystal-light emitting devices even in the red and blue parts of the spectrum, since in nanocrystal emitting devices no photons are lost to infrared and UV emission. The broadly tunable, saturated color emission over the entire visible spectrum of a single material system is unmatched by any class of organic chromophores. Furthermore, environmental stability of covalently bonded inorganic nanocrystals suggests that device lifetimes of hybrid organic/inorganic light emitting devices should match or exceed that of all-organic light emitting devices, when nanocrystals are used as luminescent centers. The degeneracy of the band edge energy levels of nanocrystals facilitates capture and radiative recombination of all possible excitons, whether generated by direct charge injection or energy transfer. The maximum theoretical nanocrystal-light emitting device efficiencies are therefore comparable to the unity efficiency of phosphorescent organic light emitting devices. The nanocrystal's excited state lifetime (τ) is much shorter (τ≈10 ns) than a typical phosphor (τ>0.5 μs), enabling nanocrystal-light emitting devices to operate efficiently even at high current density.

Other materials, techniques, methods, applications, and information that may be useful with the present invention are described in, U.S. Provisional Patent Application No. 60/792,170, of Seth Coe-Sullivan, et al., for “Composition Including Material, Methods Of Depositing Material, Articles Including Same And Systems For Depositing Material”, filed on 14 Apr. 2006; U.S. Provisional Patent Application No. 60/792,084, of Maria J. Anc, For “Methods Of Depositing Material, Methods Of Making A Device, And System”, filed on 14 Apr. 2006, U.S. Provisional Patent Application No. 60/792,086, of Marshall Cox, et al, for “Methods Of Depositing Nanomaterial & Methods Of Making A Device” filed on 14 Apr. 2006; U.S. Provisional Patent Application No. 60/792,167 of Seth Coe-Sullivan, et al, for “Articles For Depositing Materials, Transfer Surfaces, And Methods” filed on 14 Apr. 2006, U.S. Provisional Patent Application No. 60/792,083 of LeeAnn Kim et al., for “Applicator For Depositing Materials And Methods” filed on 14 Apr. 2006; U.S. Provisional Patent Application 60/793,990 of LeeAnn Kim et al., for “Applicator For Depositing Materials And Methods” filed by Express Mail on 21 Apr. 2006; U.S. Provisional Patent Application No. 60/790,393 of Seth Coe-Sullivan et al., for “Methods And Articles Including Nanomaterial”, filed on 7 Apr. 2006; U.S. Provisional Patent Application No. 60/805,735 of Seth Coe-Sullivan, for “Methods For Depositing Nanomaterial, Methods For Fabricating A Device, And Methods For Fabricating An Array Of Devices”, filed on 24 Jun. 2006; U.S. Provisional Patent Application No. 60/805,736 of Seth Coe-Sullivan et al., for “Methods For Depositing Nanomaterial, Methods For Fabricating A Device, Methods For Fabricating An Array Of Devices And Compositions”, filed on 24 Jun. 2006; U.S. Provisional Patent Application No. 60/805,738 of Seth Coe-Sullivan et al., for “Methods And Articles Including Nanomaterial”, filed on 24 Jun. 2006; U.S. Provisional Patent Application No. 60/795,420 of Paul Beatty et al., for “Device Including Semiconductor Nanocrystals And A Layer Including A Doped Organic Material And Methods”, filed on 27 Apr. 2006; U.S. Provisional Patent Application No. 60/804,921 of Seth Coe-Sullivan et al., for “Light-Emitting Devices And Displays With Improved Performance”, filed on 15 Jun. 2006, U.S. patent application Ser. No. 11/071,244 of Jonathan S. Steckel et al., for “Blue Light Emitting Semiconductor Nanocrystal Materials” 4 Mar. 2005 (including U.S. Patent Application No. 60/550,314, filed on 8 Mar. 2004, from which it claims priority), U.S. Provisional Patent Application No. 60/825,373, filed 12 Sep. 2006, of Seth A. Coe-Sullivan et al., for “Light-Emitting Devices And Displays With Improved Performance”; and U.S. Provisional Patent Application No. 60/825,374, filed 12 Sep. 2006, of Seth A. Coe-Sullivan et al., for “Light-Emitting Devices And Displays With Improved Performance”. The disclosures of each of the foregoing listed patent documents are hereby incorporated herein by reference in their entireties.

Device performance can be affected by defects (e.g., gaps) in the emissive layer, morphology of the semiconductor nanocrystal-organic transport layer interfaces, and band structure.

For example, light emitting devices including an emissive material comprising semiconductor nanocrystals can have an emitting layer that is approximately as thick as a single semiconductor nanocrystal, and hence a single missing semiconductor nanocrystal results in a device pathway in which no semiconductor nanocrystals are present. Strategies for dealing with this consideration include fabricating more complete layers to minimize the occurrences of the problem, as well as designing the energetic structure such that any voids do not negatively impact device performance.

The present invention is concerned with improving the morphology of the emissive layer interface. Morphology of the emissive layer interface is less of a concern in OLEDs. In OLEDs, most transport, host, and emissive materials are in the same basic class of aromatic organic compounds, and hence the layers have good adhesion to each other (in contrast to, for example, the problem of NPB adhesion to ITO which has been well studied).

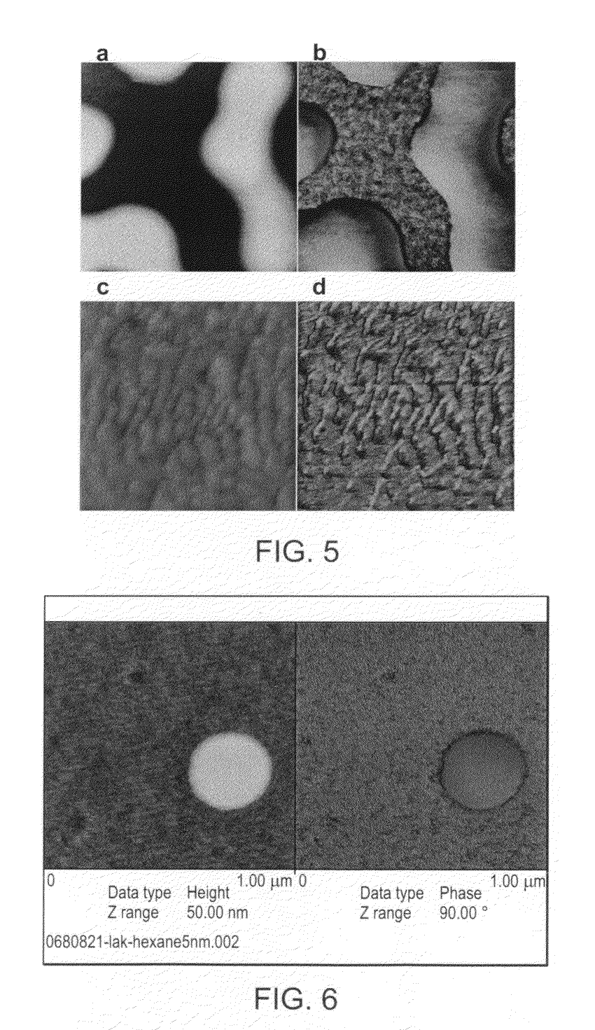

Semiconductor nanocrystals typically have ligands attached to their surface that present aliphatic end groups to any surface which they contact. By modifying the ligand design (e.g., from aliphatic to aromatic) or by selecting the constituency of the overlying layer based on the chemical affinity of the constituents relative to ligands, an interface at which the overlying layer does not wet the semiconductor nanocrystal surface on which they are being deposited is changed to an interface at which the overlying layer is highly wettable on semiconductor nanocrystals. An example of improved wettability achievable with changed ligand design (e.g., from aliphatic to aromatic) is shown in FIG. 5, which is further discussed below.

Energy band structure can also be important to device performance in both semiconductor nanocrystal-LEDs and OLEDs. Both optical band gaps and Fermi level offsets require attention to track the flow of charge and excitons within the device. Semiconductor nanocrystals have similar bandgaps to organic lumophores, but their energy offsets relative to vacuum are in general much higher than typical organic semiconductors. The result is that a semiconductor nanocrystal may act as both an efficient electron trap and as a hole blocker in operating semiconductor nanocrystal-LEDs. Additionally, the semiconductor nanocrystal emissive layer is typically in contact with both the electron and hole transporting sections in a device, and hence the optical gap of both of these materials is of critical importance. Data demonstrating the effect of different device architectures on semiconductor nanocrystal-LED performance will be presented. See, for example, International Application No. PCT/US2007/013152, entitled “Light-Emitting Devices And Displays With Improved Performance”, of QD Vision, Inc. et al., filed 4 Jun. 2007, which is referenced above.

In certain embodiments, colloidal quantum dot optical characteristics are determined by the materials used in their synthetic preparation, the resulting size distribution of the quantum dot sample, and the extent to which surface bonds are passivated by the surrounding organic ligands. In addition to optical effects of surface passivation, ligand characteristics determine a wide range of other properties of quantum dots, including, but not limited to, effective solvents and processing capabilities, surface energies, and material compatibilities. By changing these ligands one can begin to control these characteristics to benefit the nanocrystal performance in its end-use application.

As discussed above, for quantum dots included in embodiments of light emitting devices including organic layers, ligand selection can change device performance in a number of advantageous ways. If the ligands are aliphatic, for example, the aromatic transport layers will energetically prefer not to be in contact with them. The result of this incompatibility can be inefficient charge transfer, material reconfiguration (T_{g} suppression, transport layer mixing, et cetera), and the inability to evaporate a thin layer of organic on top of the nanocrystals—attempts at this invariably result in “puddling” of the organic during evaporation as the evaporated material seeks out lower energy configurations (FIG. 5). By utilizing ligands in a light emitting device that have a chemical affinity for the material of the device layer formed on the semiconductor nanocrystal layer, new device architectures can be achieved that previously could not be reliably fabricated, e.g., thin layers on top of the nanocrystal layer.

By selecting the composition of the ligands and the constituency of the layer of a device that overlies the nanocrystal layer design such that there is a chemical affinity between the ligands and the overlying layer, the QD interface morphology can be changed from a condition where, for example, organic transport materials do not wet the QD surface on which they are being deposited, to a condition where the same materials are highly wettable on QDs. FIG. 5(a) and (b) below show Atomic Force Microscope (AFM) images of 15 nm of an organic material, 4,4′-Bis(carbazol-9-yl)biphenyl (CBP), deposited on top of an aliphatic QD monolayer. The “puddling” of material shown is the organic material finding a lower energy state, steering mass transport away from a coherent thin layer. In contrast, FIG. 5(c) and (d) demonstrate superior organic deposition on newly designed QDs that can be directly attributed to the modified ligand design. These ligands enable thinner and more uniform organic thin film deposition, enabling more optimal device architectures.

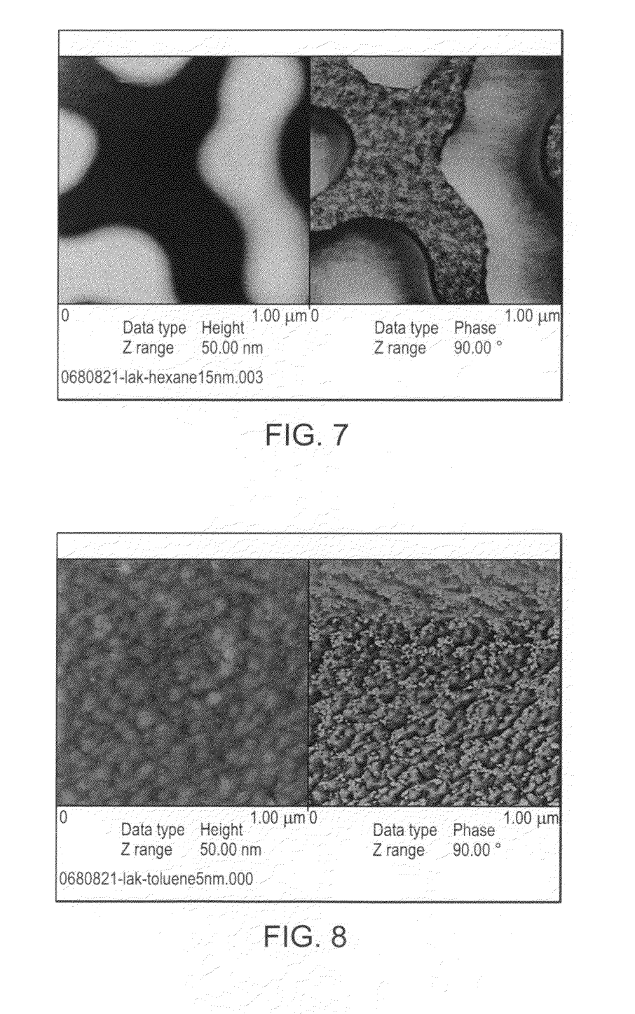

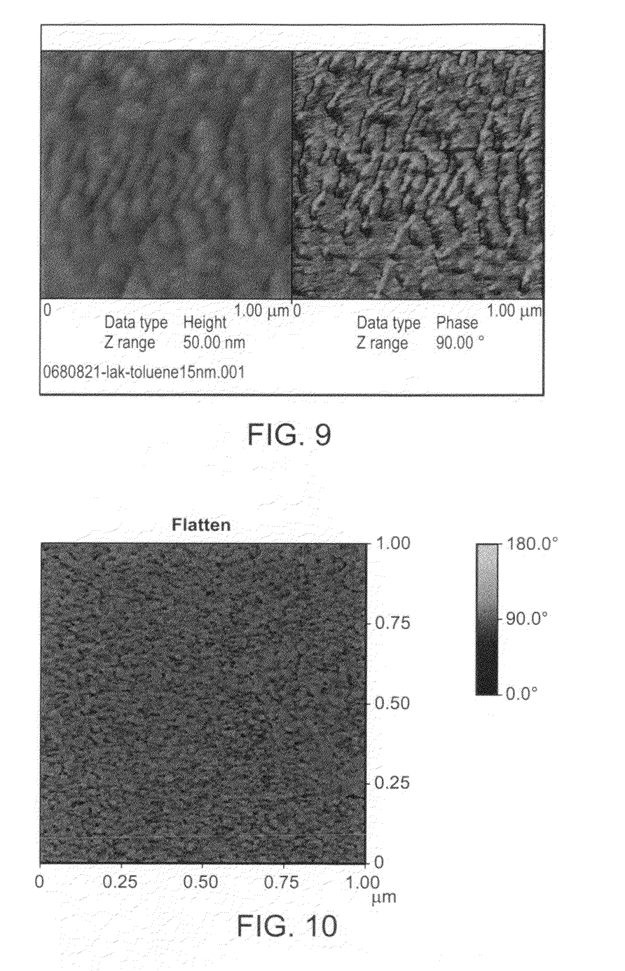

In certain preferred embodiments, the desired ligand can be attached to semiconductor nanocrystals during the synthesis of the nanocrystals. For example, while carrying out the synthetic reactions to prepare nanocrystals with TOPO as the solvent, replacing the existing aliphatic phosphonic acid and amine species with aromatic derivatives results in nanocrystals that have new surface chemistry while maintaining their optical properties. These nanocrystals are no longer dispersible in hexane, but are readily dispersible in toluene and chloroform. In addition, thin films of organic molecules can be deposited onto ordered films of these synthetically modified nanocrystals without the “puddling” (or dewetting) associated with traditional aliphatic nanocrystal surface chemistry (see FIG. 6-9). This is consistent with the belief that a phosphonic acid/amine salt is the predominant species on the surface of the nanocrystal despite the fact that TOPO is in large excess during the reaction.

As discussed above, in certain embodiments, the second layer comprises a material capable of transporting charge (e.g., electrons or holes). An example of a typical organic material that can be included in an electron transport layer includes a molecular matrix. The molecular matrix can be non-polymeric. The molecular matrix can include a small molecule, for example, a metal complex. The metal complex of 8-hydroxyquinoline can be an aluminum, gallium, indium, zinc or magnesium complex, for example, aluminum tris(8-hydroxyquinoline) (Alq₃). In certain embodiments, the electron transport material can comprise LT-N820 available from Luminescent Technologies, Taiwan. Other classes of materials in the electron transport layer can include metal thioxinoid compounds, oxadiazole metal chelates, triazoles, sexithiophenes derivatives, pyrazine, and styrylanthracene derivatives. An electron transport layer comprising an organic material may be intrinsic (undoped) or doped. Doping may be used to enhance conductivity. See, for example, U.S. Provisional Patent Application No. 60/795,420 of Beatty et al, for “Device Including Semiconductor Nanocrystals And A Layer Including A Doped Organic Material And Methods”, filed 27 Apr. 2006, which is hereby incorporated herein by reference in its entirety.

An examples of a typical organic material that can be included in a hole transport layer includes an organic chromophore. The organic chromophore can include a phenyl amine, such as, for example, N,N′-diphenyl-N,N′-bis(3-methylphenyl)-(1,1′-biphenyl)-4,4′-diamine (TPD). Other hole transport layer can include spiro-TPD, 4-4′-N,N′-dicarbazolyl-biphenyl (CBP), 4,4-bis[N-(1-naphthyl)-N-phenylamino]biphenyl (NPD), etc., a polyaniline, a polypyrrole, a poly(phenylene vinylene), copper phthalocyanine, an aromatic tertiary amine or polynuclear aromatic tertiary amine, a 4,4′-bis(p-carbazolyl)-1,1′-biphenyl compound, or an N,N,N′,N′-tetraarylbenzidine. A hole transport layer comprising an organic material may be intrinsic (undoped) or doped. Doping may be used to enhance conductivity. Examples of doped hole transport layers are described in U.S. Provisional Patent Application No. 60/795,420 of Beatty et al, for “Device Including Semiconductor Nanocrystals And A Layer Including A Doped Organic Material And Methods”, filed 27 Apr. 2006, which is hereby incorporated herein by reference in its entirety.

Charge transport layers comprising organic materials and other information related to fabrication of organic charge transport layers are discussed in more detail in U.S. patent application Ser. Nos. 11/253,612 for “Method And System For Transferring A Patterned Material”, filed 21 Oct. 2005, and 11/253,595 for “Light Emitting Device Including Semiconductor Nanocrystals”, filed 21 Oct. 2005. The foregoing patent applications are hereby incorporated herein by reference in its entirety.

Organic charge transport layers may be disposed by known methods such as a vacuum vapor deposition method, a sputtering method, a dip-coating method, a spin-coating method, a casting method, a bar-coating method, a roll-coating method, and other film deposition methods. Preferably, organic layers are deposited under ultra-high vacuum (e.g., <10⁻⁸ torr), high vacuum (e.g., from about 10⁻⁸ ton to about 10⁻⁵ ton), or low vacuum conditions (e.g., from about 10⁻⁵ ton to about 10⁻³ ton). Most preferably, the organic layers are deposited at high vacuum conditions of from about 1×10⁻⁷ to about 5×10⁻⁶ ton. Alternatively, organic layers may be formed by multi-layer coating while appropriately selecting solvent for each layer.

Charge transport layers including inorganic materials and other information related to fabrication of inorganic charge transport layers are discussed further below and in more detail in U.S. Patent Application No. 60/653,094 for “Light Emitting Device Including Semiconductor Nanocrystals”, filed 16 Feb. 2005 and U.S. patent application Ser. No. 11/354,185, filed 15 Feb. 2006, the disclosures of each of which are hereby incorporated herein by reference in their entireties.

Charge transport layers comprising an inorganic semiconductor can be deposited on a substrate at a low temperature, for example, by a known method, such as a vacuum vapor deposition method, an ion-plating method, sputtering, inkjet printing, etc.

In various embodiments, a substrate can be opaque, light transmissive, or transparent. The substrate can be rigid or flexible. The substrate can comprise plastic, metal, glass, or semiconductor (e.g., silicon).

In some applications, the substrate can further include a backplane. The backplane includes active or passive electronics for controlling or switching power to individual pixels or light-emitting devices. Including a backplane can be useful for applications such as displays, sensors, or imagers. In particular, the backplane can be configured as an active matrix, passive matrix, fixed format, direct drive, or hybrid. The display can be configured for still images, moving images, or lighting. A display including an array of light emitting devices can provide white light, monochrome light, or color-tunable light.

In addition to the charge transport layers, a device may optionally further include one or more charge-injection layers, e.g., a hole-injection layer (either as a separate layer or as part of the hole transport layer) and/or an electron-injection layer (either as a separate layer as part of the electron transport layer). Charge injection layers comprising organic materials can be intrinsic (un-doped) or doped. See, for example, U.S. Provisional Patent Application No. 60/795,420 of Beatty et al, for “Device Including Semiconductor Nanocrystals And A Layer Including A Doped Organic Material And Methods”, filed 27 Apr. 2006, which is hereby incorporated herein by reference in its entirety.

One or more charge blocking layers may still further optionally be included. For example, an electron blocking layer (EBL), a hole blocking layer (HBL), or an exciton blocking layer (eBL), can be introduced in the structure. A blocking layer can include, for example, 3-(4-biphenylyl)-4-phenyl-5-tert butylphenyl-1,2,4-triazole (TAZ), 3,4,5-triphenyl-1,2,4-triazole, 3,5-bis(4-tert-butylphenyl)-4-phenyl-1,2,4-triazole, bathocuproine (BCP), 4,4′,4″-tris{N-(3-methylphenyl)-N-phenylamino}triphenylamine (m-MTDATA), polyethylene dioxythiophene (PEDOT), 1,3-bis(5-(4-diphenylamino)phenyl-1,3,4-oxadiazol-2-yl)benzene, 2-(4-biphenylyl)-5-(4-tertbutylphenyl)-1,3,4-oxadiazole, 1,3-bis[5-(4-(1,1-dimethylethyl)phenyl)-1,3,4-oxadiazol-5,2-yl)benzene, 1,4-bis(5-(4-diphenylamino)phenyl-1,3,4-oxadiazol-2-yl)benzene, 1,3,5-tris[5-(4-(1,1-dimethylethyl)phenyl)-1,3,4-oxadiazol-2-yl)benzene, or 2,2′,2″-(1,3,5-Benzenetriyl)-tris(1-phenyl-1-H-benzimidazole) (TPBi).

Charge blocking layers comprising organic materials can be intrinsic (un-doped) or doped. See, for example, U.S. Provisional Patent Application No. 60/795,420 of Beatty et al, for “Device Including Semiconductor Nanocrystals And A Layer Including A Doped Organic Material And Methods”, filed 27 Apr. 2006, which is hereby incorporated herein by reference in its entirety.

The charge injection layers (if any), and charge blocking layers (if any) can be deposited on a surface of one of the electrodes by spin coating, dip coating, vapor deposition, or other thin film deposition methods. See, for example, M. C. Schlamp, et al., J. Appl. Phys., 82, 5837-5842, (1997); V. Santhanam, et al., Langmuir, 19, 7881-7887, (2003); and X. Lin, et al., J. Phys. Chem. B, 105, 3353-3357, (2001), each of which is incorporated by reference in its entirety.

Other multilayer structures may optionally be used to improve the performance (see, for example, U.S. patent application Ser. Nos. 10/400,907 and 10/400,908, filed Mar. 28, 2003, each of which is incorporated by reference in its entirety) of the light-emitting devices and displays of the invention. The performance of light-emitting devices can be improved by increasing their efficiency, narrowing or broadening their emission spectra, or polarizing their emission. See, for example, Bulovic et al., Semiconductors and Semimetals 64, 255 (2000), Adachi et al., Appl. Phys. Lett. 78, 1622 (2001), Yamasaki et al., Appl. Phys. Lett. 76, 1243 (2000), Dirr et al., Jpn. J. Appl. Phys. 37, 1457 (1998), and D'Andrade et al., MRS Fall Meeting, BB6.2 (2001), each of which is incorporated herein by reference in its entirety.

Examples of additional materials useful for inclusion in second layers include, without limitation, polymerized fluorocarbons, polylaurylmethacrylate (PLMA), polymethylmethacrylate (PMMA), polystyrene and parylene materials.

Preferably, a light-emitting device including an emissive material comprising a plurality of semiconductor nanocrystals is processed in a controlled (oxygen-free and moisture-free) environment, preventing the quenching of luminescent efficiency during the fabrication process.

The present invention will be further clarified by the following examples, which are intended to be exemplary of the present invention.

### EXAMPLES

### Example 1

### Preparation of Aromatic Semiconductor Nanocrystals Capable of Emitting Red Light

Synthesis of CdSe Cores: 1 mmol cadmium acetate was dissolved in 8.96 mmol of tri-n-octylphosphine at 100° C. in a 20 mL vial and then dried and degassed for one hour. 15.5 mmol of trioctylphosphine oxide and 2 mmol of octadecylphosphonic acid were added to a 3-neck flask and dried and degassed at 140° C. for one hour. After degassing, the Cd solution was added to the oxide/acid flask and the mixture was heated to 270° C. under nitrogen. Once the temperature reached 270° C., 8 mmol of tri-n-butylphosphine was injected into the flask. The temperature was brought back to 270° C. where 1.1 mL of 1.5 M TBP-Se was then rapidly injected. The reaction mixture was heated at 270° C. for 15-30 minutes while aliquots of the solution were removed periodically in order to monitor the growth of the nanocrystals. Once the first absorption peak of the nanocrystals reached 565-575 nm, the reaction was stopped by cooling the mixture to room temperature. The CdSe cores were precipitated out of the growth solution inside a nitrogen atmosphere glovebox by adding a 3:1 mixture of methanol and isopropanol. The isolated cores were then dissolved in hexane and used to make core-shell materials.

Synthesis of CdSe/CdZnS Core-Shell Nanocrystals: 25.86 mmol of trioctylphosphine oxide and 2.4 mmol of benzylphosphonic acid were loaded into a four-neck flask. The mixture was then dried and degassed in the reaction vessel by heating to 120° C. for about an hour. The flask was then cooled to 75° C. and the hexane solution containing isolated CdSe cores (0.1 mmol Cd content) was added to the reaction mixture. The hexane was removed under reduced pressure and then 2.4 mmol of phenylethylamine was added to the reaction mixture. Dimethyl cadmium, diethyl zinc, and hexamethyldisilathiane were used as the Cd, Zn, and S precursors, respectively. The Cd and Zn were mixed in equimolar ratios while the S was in two-fold excess relative to the Cd and Zn. The Cd/Zn and S samples were each dissolved in 4 mL of trioctylphosphine inside a nitrogen atmosphere glove box. Once the precursor solutions were prepared, the reaction flask was heated to 155° C. under nitrogen. The precursor solutions were added dropwise over the course of 2 hours at 155° C. using a syringe pump. After the shell growth, the nanocrystals were transferred to a nitrogen atmosphere glovebox and precipitated out of the growth solution by adding a 3:1 mixture of methanol and isopropanol. The isolated core-shell nanocrystals were then dissolved in toluene. The semiconductor nanocrystals had an emission maximum of 616 nm with a FWHM of 34 nm and a solution quantum yield of 50%.

### Example 2

### Sample Fabrication

Cleaned glass substrates were ashed in a plasma preen and coated with PEDOT:PSS (70 nm). Substrates were taken into a nitrogen environment and baked at 120 C for 20 minutes. 50 nm E105 (N,N′-Bis(3-methylphenyl)-N,N′-bis-(phenyl)-9,9-spiro-bifluorene, LumTec) was evaporated in a vacuum chamber below 2e-6 Torr via thermal evaporation. Application of aromatic quantum dots was accomplished via contact printing. A dispersion of semiconductor nanocrystals with an optical density (OD) of 0.3 at the 1^{st} absorption feature was spin-coated at 3000 rpm on a parylene coated stamp for 60 seconds, which was then stamped onto the E105 substrates depositing a mono-layer of aromatic quantum dots. Substrates were then taken back into the thermal evaporation chamber, and 5 nm and 15 nm, respectively, of CBP (4,4′-Bis(carbazol-9-yl)biphenyl, LumTec) were evaporated below 2e-6 Ton. FIG. 5(a)-(d) and FIG. 6-9 depict images of the samples described in this Example 2.

### Example 3

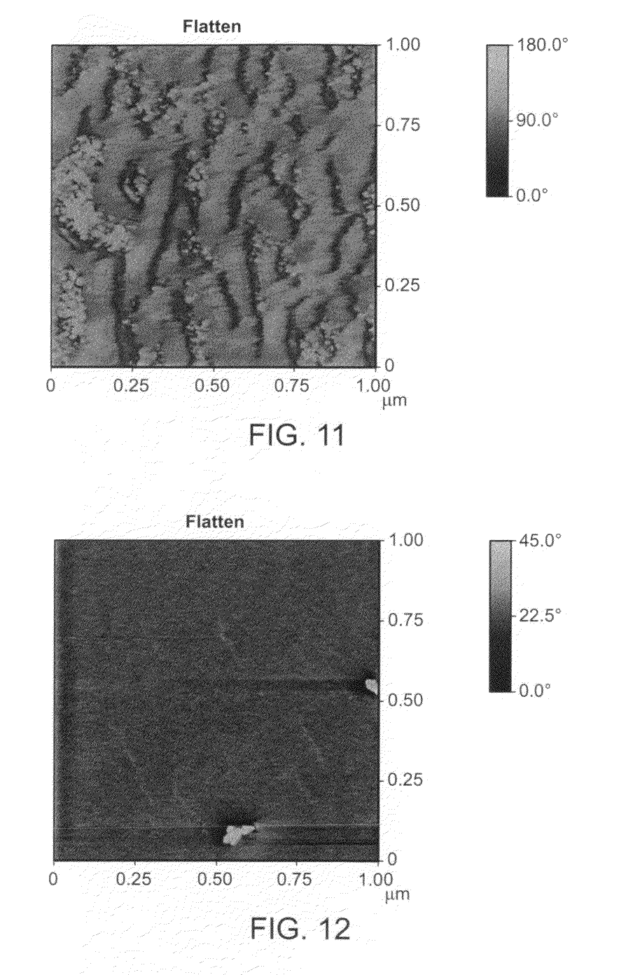

FIG. 11-12 show AFM images of additional examples of composites including a first layer comprising semiconductor nanocrystals including ligands with aromatic functionalities and a second layer comprising DOFL-CBP (2,7-Bis(9-carbazolyl)-9,9-dioctylfluorene). (DOFL-CBP is available from Luminescence Technology Corp., 2F, No. 21 R&D Road, Science-Based Industrial Park, Hsin-Chu, Taiwan, R.O.C., 30076.) The semiconductor nanocrystals in the depicted samples were prepared by a method similar to that described in Example 1, but in the absence of the amine species (phenylethylamine). FIG. 10 shows a layer of such semiconductor nanocrystals including ligands with aromatic functionalities on a glass substrate. FIG. 11 shows a layer of semiconductor nanocrystals similar to those shown in FIG. 10 with a 5 nm layer of DOFL-CBP formed on the nanocrystal layer. FIG. 12 shows a layer of semiconductor nanocrystals similar to those shown in FIG. 10 with a 15 nm layer of DOFL-CBP formed on the nanocrystal layer. (The white areas on the bottom and right edges of the AFM image just above 0.5 appear to be particulates on the top surface of the DOFL-CBP layer.) In both FIGS. 11 and 12, the layer of DOFL-CBP in continuous or uninterrupted by voids.

Examples of other variations for synthesizing semiconductor nanocrystals with aromatic surface functionality include the following. The overcoating process can be carried out in the absence of any ligand with an aliphatic group. In other words, the procedure can be performed without trioctylphosphine oxide (TOPO) or trioctylphosphine (TOP) and instead use a non-coordinating solvent (e.g., squalane). In order to maintain solubility of the semiconductor nanocrystals made in this process, multiple distinct aromatic phosphonic acid species and/or multiple distinct aromatic amine species will need to be present in the reaction in order to break-up crystallization or ordered packing of ligand species (both intra-quantum dot and inter-quantum dot) and allow the semiconductor nanocrystals (or quantum dots) to be dispersed in various solvent systems.

In certain embodiments, semiconductor nanocrystals are purified before deposition.

In certain embodiments, a desired ligand can be attached to a semiconductor nanocrystal by building the desired functionality into the phosphonic acid derivative, amine derivative, or both. Following is a non-limiting example of a schematic of a general synthetic procedure for generating a desired phosphonic acid derivative:

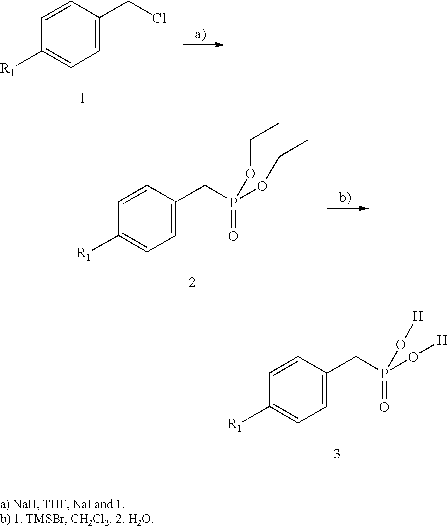

Also refer to The Chemistry of Organophosphorus Compounds, Volume 4: Ter-and Quinque-Valent Phosphorus Acids and Their Derivatives, Frank R. Hartley (Editor), April 1996 for more general synthetic procedures for generating phosphonic acid derivatives.

In certain additional embodiments, a desired ligand can be attached to a semiconductor nanocrystal by building the desired functionality into the phosphonic acid derivative, amine derivative, or both. Following is a non-limiting example of a schematic of a general synthetic procedure for generating a desired amine derivative:

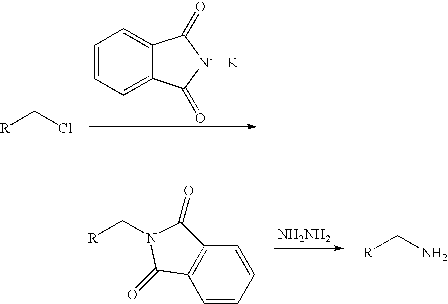

Alternatively, as described above, in certain embodiments, ligands attached to a nanocrystal that are derived from the coordinating solvent used during the growth process can be exchanged with a desired ligand. The surface can be modified by repeated exposure to an excess of a competing coordinating group to form an overlayer. For example, a dispersion of the capped semiconductor nanocrystal can be treated with a coordinating organic compound, such as pyridine, to produce crystallites which disperse readily in pyridine, methanol, and aromatics but no longer disperse in aliphatic solvents. Such a surface exchange process can be carried out with any compound capable of coordinating to or bonding with the outer surface of the semiconductor nanocrystal, including, for example, phosphines, thiols, amines and phosphates. The semiconductor nanocrystal can be exposed to small molecules, short chain polymers, other organic or inorganic materials, which exhibit an affinity for the surface and which terminate in a moiety having an affinity for the second layer to be disposed on the first layer of the composite comprising nanoparticles (e.g., semiconductor nanocrystals or other examples of nanoparticles described above).

As used herein, the singular forms “a”, “an” and “the” include plural unless the context clearly dictates otherwise. Thus, for example, reference to an emissive material includes reference to one or more of such materials.

When an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

The terms and expressions which have been employed herein are used as terms of description and not of limitation, and there is no intention in the use of such terms and expressions of excluding equivalents of the features shown and described, or portions thereof, it being recognized that various modifications are possible within the scope of the invention claimed. Moreover, any one or more features of any embodiment of the invention may be combined with any one or more other features of any other embodiment of the invention, without departing from the scope of the invention. Additional embodiments of the present invention will also be apparent to those skilled in the art from consideration of the specification and practice of the invention disclosed herein. It is intended that the specification and examples be considered as exemplary only, with a true scope and spirit of the invention being indicated by the following claims and equivalents thereof.

All patents, patent applications, and publications mentioned above are herein incorporated by reference in their entirety for all purposes. None of the patents, patent applications, and publications mentioned above are admitted to be prior art.

1. A composite including a first layer comprising nanoparticles, at least a portion of which include a ligand attached to a surface of a nanoparticle, and a second layer disposed over a predetermined area of the first layer, wherein the second layer comprises an organic material, is uninterrupted by voids across the predetermined area, and has a thickness less than or equal to about 30 nm.

2. A composite including a first layer comprising nanoparticles, at least a portion of which include a ligand attached to a surface of a nanoparticle, and a second layer disposed over a predetermined area of the first layer, wherein the second layer comprises an evaporable material, is uninterrupted by voids across the predetermined area, and has a thickness less than or equal to about 30 nm.

3. A composite including a first layer comprising nanoparticles, at least a portion of which include a ligand attached to a surface of a nanoparticle, and a second layer disposed over a predetermined area of the first layer, wherein the second layer includes a base material and less than 75% by weight semiconductor nanoparticles, is uninterrupted by voids across the predetermined area, and has a thickness less than or equal to about 30 nm.

4. A composite in accordance with claim 1 wherein the second layer has a chemical affinity for the ligand.

5. A composite in accordance with claim 2 wherein the second layer has a chemical affinity for the ligand.

6. A composite in accordance with claim 3 wherein the second layer has a chemical affinity for the ligand.

7. (canceled)

8. (canceled)

9. (canceled)

10. (canceled)

11. (canceled)

12. (canceled)

13. (canceled)

14. (canceled)

15. (canceled)

16. (canceled)

17. A composite in accordance with claim 2 wherein the evaporable material comprises an organic material.

18. A composite in accordance with claim 2 wherein the evaporable material comprises an inorganic material.

19. (canceled)

20. (canceled)

21. (canceled)

22. (canceled)

23. A composite in accordance with claim 3 wherein the base material comprises an organic material.

24. A composite in accordance with claim 3 wherein the base material comprises an inorganic material.

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. A composite in accordance with claim 3 wherein the base material includes no semiconductor nanocrystals.

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. (canceled)

62. (canceled)

63. (canceled)

64. (canceled)

65. (canceled)

66. (canceled)

67. (canceled)

68. (canceled)

69. (canceled)

70. (canceled)

71. (canceled)

72. (canceled)

73. (canceled)

74. (canceled)

75. (canceled)

76. (canceled)

77. (canceled)

78. (canceled)

79. (canceled)

80. (canceled)

81. (canceled)

82. (canceled)

83. (canceled)

84. (canceled)

85. (canceled)

86. (canceled)

87. (canceled)

88. (canceled)

89. (canceled)

90. (canceled)

91. (canceled)

92. (canceled)

93. (canceled)

94. (canceled)

95. (canceled)

96. (canceled)

97. (canceled)

98. (canceled)

99. (canceled)

100. (canceled)

101. (canceled)

102. (canceled)

103. (canceled)

104. (canceled)

105. (canceled)

106. (canceled)

107. A composite in accordance with claim 1 wherein the nanoparticles comprise semiconductor nanocrystals.

108. A composite in accordance with claim 107 wherein at least a portion of the semiconductor nanocrystals comprise a core and a shell disposed on at least a portion of the core.

109. A composite in accordance with claim 2 wherein the nanoparticles comprise semiconductor nanocrystals.

110. A composite in accordance with claim 109 wherein at least a portion of the semiconductor nanocrystals comprise a core and a shell disposed on at least a portion of the core.

111. A composite in accordance with claim 3 wherein the nanoparticles comprise semiconductor nanocrystals.

112. A composite in accordance with claim 111 wherein at least a portion of the semiconductor nanocrystals comprise a core and a shell disposed on at least a portion of the core.

113. A composite in accordance with claim 1 wherein the thickness of the second layer varies by less than or equal to 5 nm across the predetermined area.

114. A composite in accordance with claim 2 wherein the thickness of the second layer varies by less than or equal to 5 nm across the predetermined area.

115. A composite in accordance with claim 3 wherein the thickness of the second layer varies by less than or equal to 5 nm across the predetermined area.

116. A composite in accordance with claim 1 wherein the second layer is disposed directly on the predetermined area of the first layer.

117. A composite in accordance with claim 2 wherein the second layer is disposed directly on the predetermined area of the first layer.

118. A composite in accordance with claim 3 wherein the second layer is disposed directly on the predetermined area of the first layer.

119. A composite in accordance with claim 1 wherein the ligand includes an aromatic group.

120. A composite in accordance with claim 2 wherein the ligand includes an aromatic group.

121. A composite in accordance with claim 3 wherein the ligand includes an aromatic group.

122. A composite in accordance with claim 1 wherein the ligand includes an aliphatic group.

123. A composite in accordance with claim 2 wherein the ligand includes an aliphatic group.

124. A composite in accordance with claim 3 wherein the ligand includes an aliphatic group.

125. A composite in accordance with claim 1 wherein the second layer has a thickness of 20 nm or less.

126. A composite in accordance with claim 2 wherein the second layer has a thickness of 20 nm or less.

127. A composite in accordance with claim 3 wherein the second layer has a thickness of 20 nm or less.

128. A composite in accordance with claim 1 wherein the second layer thickness of 10 nm or less.

129. A composite in accordance with claim 2 wherein the second layer thickness of 10 nm or less.

130. A composite in accordance with claim 3 wherein the second layer thickness of 10 nm or less.
